(19) United States
(12) Patent Application Publication
(10) Pub. No.: US 2018/0276582 A1
(43) Pub. Date: Sep. 27, 2018

(54) GEOLOCATION ASSIST PLANT OPERATION MANAGEMENT SYSTEM

(71) Applicant: YOKOGAWA ENGINEERING ASIA PTE. LTD, Singapore (SG)

(72) Inventors: Jinsong QIAN, Singapore (SG); Lwin Lwin TUN, Singapore (SG); Amit Ulhasrao WADASKAR, Singapore (SG); Jiabao XIE, Singapore (SG)

(73) Assignee: YOKOGAWA ENGINEERING ASIA PTE. LTD, Singapore (SG)

(21) Appl. No.: 15/468,491

(22) Filed: Mar. 24, 2017

(51) Int. Cl. G06Q 10/06; G01S 5/02

(52) U.S. Cl. CPC G06Q 10/0635; G01S 5/0252; G01S 5/0278; G06Q 10/06311

(57) ABSTRACT

A system and method related to a geolocation assist plant operation management system, utilizing geolocation with regards to components of the industrial plant and operators. The usage of geolocation provides for real-time information as to the location of operators relative to components that may require inspection. Additionally, the use of geolocation may provide warnings for operators to be cognizant of potential dangers due to the components or the environment that the components are located in.

### FIELD OF THE INVENTION

Exemplary embodiments relate to geolocation integration with operation management systems and methods, the management of industrial automation processes with potential risk assessments, and the automatic scheduling of optimized inspection routing for task completion and operator safety.

### BACKGROUND

In the related art concerning industrial plant environments, it is important to monitor and maintain the operability of processes and workflows of an industrial plant in order to maintain safe, efficient and reliable operations. Within an industrial plant, there are many components that are necessary for continued operation. Components will degrade simply due to wear from extended periods of deployment. Additionally, with the large components, high power draws, and connected workflows, it is important to monitor processes to prevent catastrophic failures and injuries to operators. Beyond the structure and operation of components, the environmental conditions for the components may also vary over time, affecting the operation of the component.

Although a remote monitoring system using sensors or feedback from the components may be used to monitor operating parameters, there may still be scenarios where the remote monitoring system cannot detect abnormalities. As such, it is normal for industrial plants to also schedule routine patrols by operators to physically inspect areas of the industrial plant.

The routine patrol enables the operator to physically see any abnormalities in the process components. The routine patrol also allows for monitoring of any environmental changes or concerns for proper functioning of the components.

### SUMMARY

One or more embodiments of the present application are directed towards a method for integration of component geolocation data with operation management of an industrial automation process for an industrial facility for risk assessment. The method includes acquiring geolocation data for a process component within the industrial facility, accessing historical operational information for the process component, and associating the geolocation data of the process component with the historical operational information of the process component, and calculating statistical trends from the historical operational information. The method further includes determining an optimized route for an operator to follow based on the statistical trends, comparing whether a risk from an environment the process component is in and the process component exceeds a preset risk threshold, activating a processor, when the risk exceeds the preset risk threshold, to access the stored optimized route, access a geolocation of the operator, and integrate the geolocation of the operator and the stored optimized route to dynamically and automatically redetermine the route for the operator, and automatically send a communication for displaying and notifying the operator of the redetermined route.

In some embodiments, the method further includes displaying a first graphical display with a map and an area for a listing of the historical operational information, wherein the map is selectable for a particular geolocation area and the listing of the historical operational information is narrowed to match the particular geolocation area

Also, the method may further include displaying a second graphical display with the map and an area for the statistical trends from the historical operational information.

In addition, the method may include sending an alert to a remote management device when the risk exceeds the preset risk threshold.

Embodiments of the method may also include wherein the communication for displaying and notifying the operator of the redetermined route includes a task and standard operating procedure steps for completion of the task.

The method may further comprise displaying an indication demarcating a high-risk area of the industrial automation process where the risk exceeds the preset risk threshold.

One or more embodiments of the present application are directed towards a system for integration of geolocation data with operation management of an industrial automation process for an industrial facility for risk assessment. The system includes a process component, at least one non-transitory computer readable storage medium operable to store program code, and at least one processor operable to read said program code and operate as instructed by the program code. The program code includes acquiring geolocation data for the process component within the industrial facility, accessing historical operational information for the process component, and associating the geolocation data of the process component with the historical operational information of the process component, calculating statistical trends from the historical operational information, determining a route for an operator based on the statistical trends, comparing whether a risk from an environment the process component is in and the process component exceeds a preset risk threshold, activating a processor, when the risk exceeds the preset risk threshold, to access the stored optimized route, access a geolocation of the operator, and integrate the geolocation of the operator and the stored optimized route to dynamically, automatically redetermine the route for the operator, and automatically sending a communication for displaying and notifying the operator of the redetermined route.

In some embodiments, the program code may further comprise code for controlling the display of a first graphical display with a map and an area for a listing of the historical operational information, wherein the map is selectable for a particular geolocation area and the listing of the historical operational information is narrowed to match the particular geolocation area

In addition, the program code may further comprise code for controlling the display of a second graphical display with the map and an area for the statistical trends from the historical operational information.

Also, the program code may further comprise code for sending an alert to a remote management device when the risk exceeds the preset risk threshold.

Embodiments of the system may also include wherein the communication for displaying and notifying the operator of the redetermined route includes a task and standard operating procedure steps for completion of the task.

The system may also include the program code for controlling the display an indication demarcating a high-risk area of the industrial automation process where the risk exceeds the preset risk threshold.

### BRIEF DESCRIPTION OF THE DRAWINGS

FIG. 1 illustrates an embodiment of a configuration for implementation of the subcomponents of the geolocation assist plant operation management system.

FIG. 2 illustrates the geolocation subcomponents of the geolocation assist plant operation management system.

FIG. 3 illustrates an embodiment of the task manager and its relationship with the geolocation builder wizard and the plant operation system.

FIG. 4 shows a graphical display with a text region and a map of the industrial plant.

FIG. 5 shows a graphical display with a text region and a map of the industrial plant along with a selectable trend graph.

FIG. 6 shows a graphical display with a text region and a map of the industrial plant along with a selectable trend graph.

FIG. 7 illustrates an exemplary embodiment of a graphical display with a text region and a map of the industrial plant.

FIG. 8 illustrates an exemplary embodiment of the patrol routing optimizer with a route optimizer and a task optimizer.

FIG. 9 illustrates a flowchart of an exemplary embodiment for automatically redetermining the route of an operator based on risk monitoring.

FIG. 10 illustrates a flowchart of the basis for the real-time risk monitor. The real-time risk monitor includes a risk generator that is configured to alert an operator to warnings based on geolocation data.

FIG. 11 illustrates an exemplary graphical display showing the outputs of the risk generator.

FIG. 12 illustrates an exemplary embodiment of the real-time risk monitor 1206 with a risk generator.

FIG. 13 illustrates an exemplary graphical display showing the outputs of the real-time risk monitor.

FIG. 14 illustrates a flowchart of an exemplary embodiment for automatically redetermining the route of an operator based on risk monitoring.

FIG. 15 illustrates a flowchart of an exemplary embodiment for determining efficiency of an operator.

### DETAILED DESCRIPTION

Embodiments will be described below in more detail with reference to the accompanying drawings. The following detailed descriptions are provided to assist the reader in gaining a comprehensive understanding of the methods and/or systems described herein, and equivalent modifications. Accordingly, various changes, modifications, and equivalents of the systems and/or methods described herein will be suggested to those of ordinary skill in the art. Also, descriptions of well-known functions and constructions may be omitted for increased clarity and conciseness.

The terms used in the description are intended to describe embodiments only, and shall by no means be restrictive. Unless clearly used otherwise, expressions in a singular form include a meaning of a plural form. In the present description, an expression such as “comprising” or “including” is intended to designate a characteristic, a number, a step, an operation, an element, a part or combinations thereof, and shall not be construed to preclude any presence or possibility of one or more other characteristics, numbers, steps, operations, elements, parts or combinations thereof.

One or more embodiments of the present application are directed towards a geolocation assist plant operation management system, utilizing geolocation with regards to components of the industrial plant and operators. The usage of geolocation provides for real-time information as to the location of operators relative to components that may require inspection. Additionally, the use of geolocation may provide warnings for operators to be cognizant of potential dangers due to the components or the environment that the components are located in. If a risk to the operator is too high, the operation management system may automatically redetermine the route of the operator. In this way, the operation management system can also provide information to optimize patrol routes for the operators on the routine patrols. The application of geolocation can provide for safer and more reliable monitoring of the industrial plant as compared to a normal set patrol route. The integration of geolocation with the operation management system can improve plant scheduling and improve operation efficiency, thereby improving plant safety and operation reliability

Also, the use of geolocation can lower the amount of time spent on patrol. For example, the geolocation data may be used to redetermine the route of an operator in the industrial plant to check a component that a previously scheduled patrol missed. In industrial plants of significant size where there may be multiple patrol routes, the ability to redetermine the route of a nearby operator to check on a missed component may significantly shorten the time between inspections.

The use of geolocation with an operation management system can also provide on-the-fly redetermination of routes for operators in the case where a plurality of operators is operating in an area. Based on the location of the operators when a scheduled task is completed, the operation management system can reroute the operators for updated optimize patrol pattern. Optimization can be based on a number of options, including shortest detour from original route, shortest overall time, or shortest overall distance.

By improving the efficiency of scheduling tasks for the industrial plant, plant safety and reliability can be improved to prevent unplanned downtime and financial loss. In addition to the potential of unplanned downtime and financial loss, there is the possibility of a catastrophic failure and injury to operators if abnormalities are not corrected.

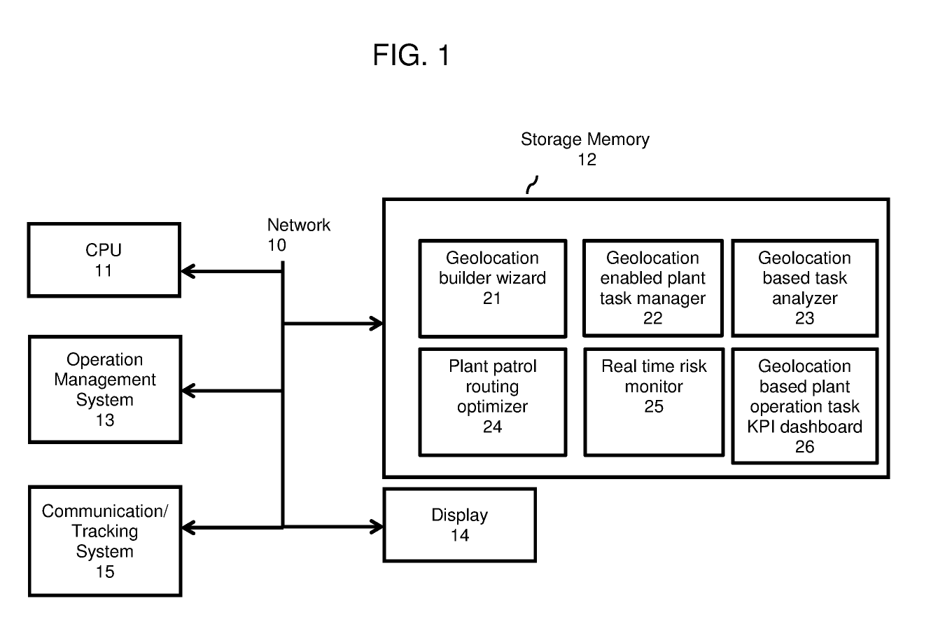

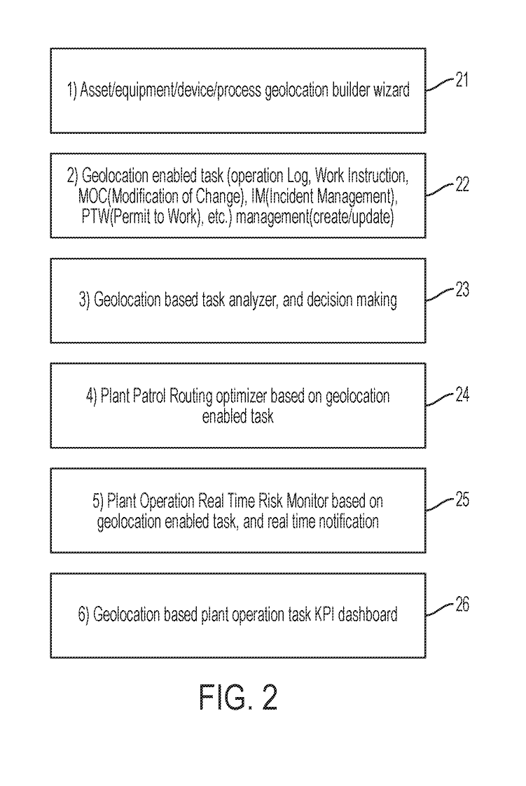

FIG. 2 illustrates the geolocation subcomponents of the geolocation assist plant operation management system. Embodiments of the operation management system comprise combinations of the subcomponents in a layered structure. The subcomponents of the geolocation builder wizard 21, geolocation enabled plant task manager 22, geolocation based task analyzer 23, plant patrol routing optimizer 24, real time risk monitor 25, and geolocation based plant operation task KPI dashboard 26 may be hardware or software, or a combination of both. They may all operate from a processor and a storage memory, or they may be compartmentalized with a plurality of processors and storage memories. FIG. 1 illustrates an embodiment of a configuration for implementation of the subcomponents of the geolocation assist plant operation management system. The subcomponents of the geolocation builder wizard 21, geolocation enabled plant task manager 22, geolocation based task analyzer 23, plant patrol routing optimizer 24, real time risk monitor 25, and geolocation based plant operation task KPI dashboard 26 are stored as program code in a storage medium 12. A processor 11 is configured to execute the program code of the subcomponents from the storage medium 12. The processor can also communicate with an operation management system 13 to retrieve tasks or historical log records. A display 14 can output a user interface as necessary for the executed subcomponents. Additionally, a communication or tracking system 15 is connected in order to receive and send information from the operators or plant components for real-time information. All of the hardware may be connected in a network 10.

Geolocation Builder Wizard

The operation management system includes an asset equipment device process geolocation builder wizard 21. The geolocation builder wizard 21 provides tools for operators to create data for correlating geolocation with asset, equipment, device, and process unit master data and plant.

The geolocation builder wizard 21 provides functionalities including automatically constructing geolocation data for plant assets, equipment, devices, and process units based on graphical data from a distributed control system (DCS), such as the CENTUM VP®, device data from an asset management system, such as PRM®, and map data. The geolocation builder wizard 21 provides the base correlation between plant components and geolocation data.

The geolocation builder wizard 21 may also provide for fine-tuning and managing geolocation data for plant assets, equipment, devices, and process units based on plant asset hierarchy data & data from the automatically constructed geolocation data. One or more embodiments for management of geolocation data can include storing hierarchical data for plant assets. Organization in a hierarchical fashion with a tree structure would allow for batch updating of information, as all components of a sub-branch having a particular geolocation can be updated by managing a higher layer of the hierarchy. In this way, the geolocation builder wizard 21 can update geolocation data for all nodes of asset, device, equipment, and process unit under a particular node of the tree.

Embodiments of the geolocation builder wizard 21 can also fine-tune and manage geolocation data by importing data from external data sources, such as a space database, an external file, or other storage.

Geolocation Enabled Plant Task Manager

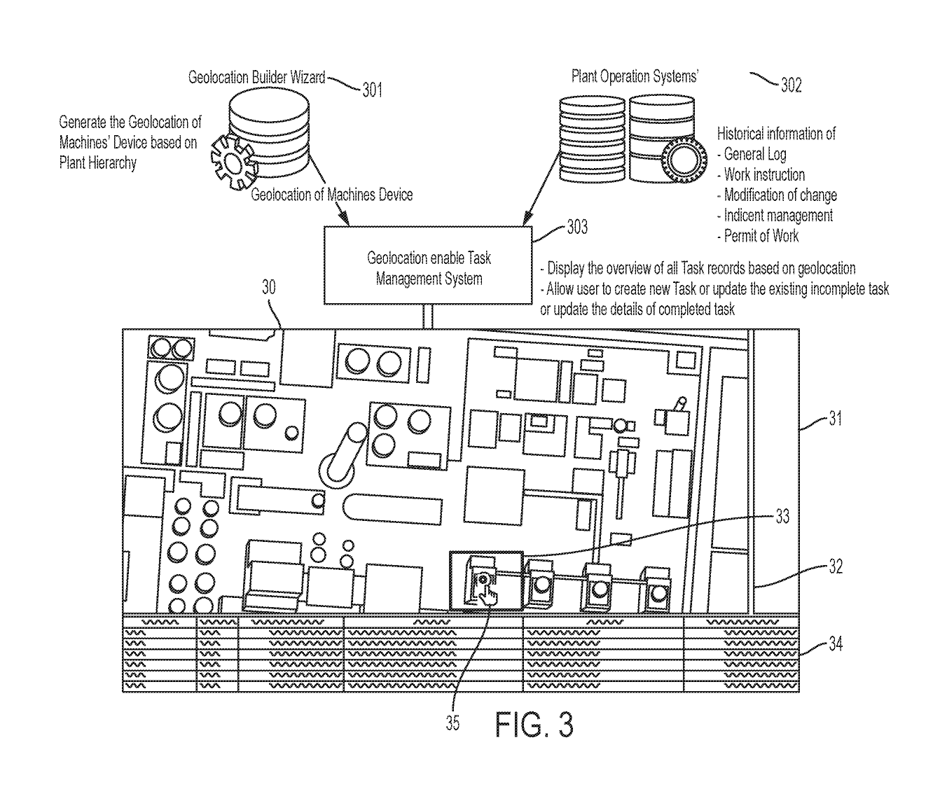

There is also a geolocation enabled plant task manager 22 subcomponent. The task manager 22 allows for associating geolocation data with plant operation stored data. The task manager 22 provides a functionality for operators to create tasks, access tasks, and access task records. FIG. 3 illustrates an embodiment of the task manager 303 and its relationship with the geolocation builder wizard 301 and the plant operation system 302. The geolocation builder wizard 301 can provide the geolocation of the plant components. The plant operation system 302 provides historical operational information including a general log system, a work instruction system, a modification of change (MOC) system, an incident management (IM) system, a routine patrol log, and a permit to work (PTW) system.

The historical operational information from the plant operation system 302 provides the logs of data regarding the processes or workflows. For example, the general log system may allow for an operator to take note of any issues that occurring at the plant. This information can be used for issue monitoring and provides continuity between different employees during shift changes. The work instruction system provides for work task dispatches from a managerial operator to subordinates. The work instruction subsystem allows for tracking of work task progress. The MOC system can provide tools tracking and recording changes made to the plant by operators. It allows plant operators to create change requests and coordinate completion of the task to implement the change requests. The IM system can provide tracking and recording of incidents that may affect safety or security. The routine patrol log can provide tracking for scheduled, recurring tasks. The PTW system can be used to manage approval for individual operators to perform or review particular tasks.

From the geolocation data of the geolocation builder wizard 301 and the systems of the plant operation system 302, the task manager 303 can then associate the geolocation data of various plant components to tasks or logs that also correspond to the plant component. To achieve this, the geolocation enabled task manager may automatically use global positioning system (GPS) or it may use a manual configuration method.

In the automatic, auto-fill, method, where GPS data is available for a plant component corresponding to a task, the geolocation data is automatically correlated with the task or record log.

In the manual, semi-fill, method, where GPS data is unavailable, the operator can choose the desired corresponding geolocation data for a task. The desired geolocation data will then be attached to the task or record log. Methods for choosing of the desired corresponding geolocation data can include selection on a graphical map or from a list of locations, wherein the locations have preset geolocation data. For example, the task manager may have a predetermined subdivision of the industrial plant, with each subdivision having preset geolocation data representation.

An embodiment illustrating a user interface for the task manager 303 is shown with a graphical display 30 having a map 32 of the industrial plant and an overview area of records 34. The area of records 34 is also selectable to access and modify or view individual records, such as tasks or historical logs. An additional text region 31 on the graphical display may provide relevant information for areas of the industrial plant. In view of the correlation of geolocation data with tasks, selection of a particular area 33 through use of a cursor 35 can then focus the area of records 34 to display the records for the particular area 33. The shape of the particular area 33 may be preset in shape and size, or it may be specifiable by use of the cursor 35 and drawing a shape on the map. For example, the shapes of the particular area may be a rectangle, circle, ellipse, triangle, or a freeform polygon. Upon selection of a particular area, the display of the map 32 may also scale to provide sufficient detail for the desired particular area.

As a result of the ease of access to displaying records, either overall or specific to a particular area, operators can easily use the graphical display 30 to access and modify tasks. In this way, embodiments can provide operators a simple user interface for creating and rescheduling tasks through the data from the geolocation builder wizard 301 and task manager 302.

Beyond the ability to graphically select particular areas of the industrial plant and see the related tasks, from the task manager 303, correlation of specific tasks with geolocation data can serve to provide a relationship or correlation that can be used to identify an operator's metrics, such as task operation efficiency, risk factor, or plant patrol efficiency.

Geolocation Based Task Analyzer

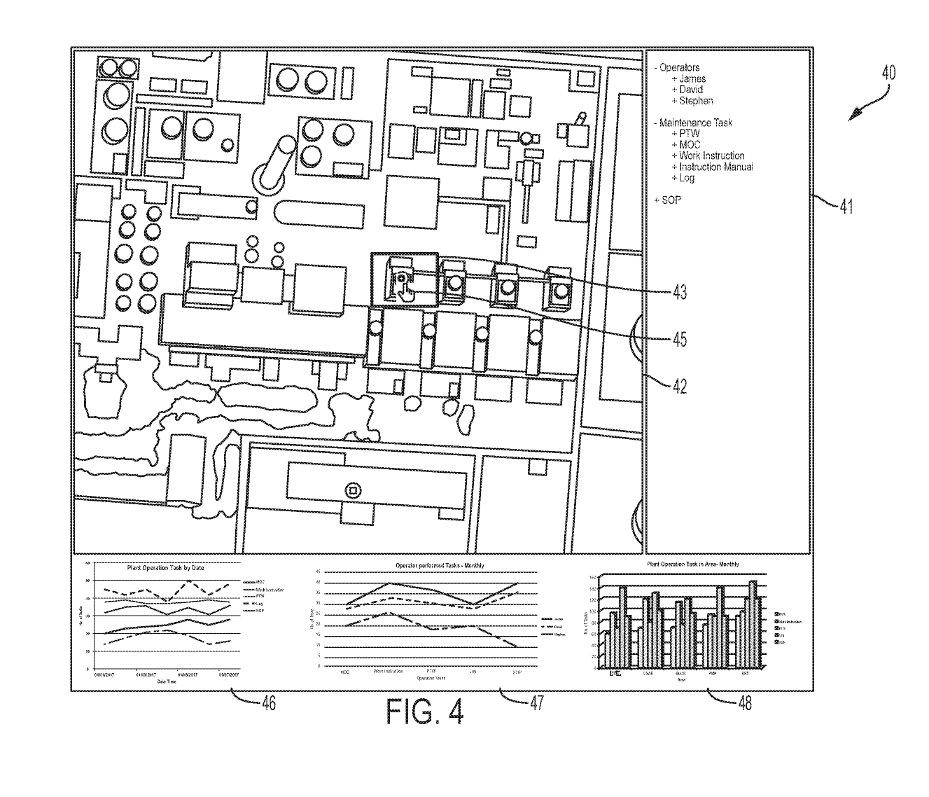

The geolocation based task analyzer 23 of FIG. 2 is further detailed in FIGS. 4-6.

The task analyzer 23 is a calculation decision making module that analyzes the correlated geolocation data and tasks from the task manager 22. An exemplary user interface is shown in FIG. 4. Similar to FIG. 3, FIG. 4 shows a graphical display 40 with a text region 41 and a map 42 of the industrial plant. The operator is also provided the use of a cursor 45, through which a particular area 43 can be selected. The shape of the particular area 43 may be preset in shape and size, or it may be specifiable by use of the cursor 45 and drawing a shape on the map. For example, the shapes of the particular area may be a rectangle, circle, ellipse, triangle, or a freeform polygon. The graphical display 40 also provides a plurality of analyzed and generated graphs to represent the data regarding tasks for trending analyze.

Embodiments include generating graphs for plant task data based on a time dimension, and/or location dimension view, and/or task type dimension, and/or task operator. For example, a daily graph 46 may be a number of tasks sorted by date graph. Another monthly graph 47 may be the types of tasks performed, sorted by operator, for a given month. Still, another monthly graph 48 may be the number of tasks in an area. In addition to the generating of graphs, embodiments may further include the ability to generate trend lines and standard deviations of the data sets for visual display.

Clicking on a particular area of the map 42 of the plant can narrow the analysis to the tasks of the particular area and displays the corresponding trend graphs for the particular area.

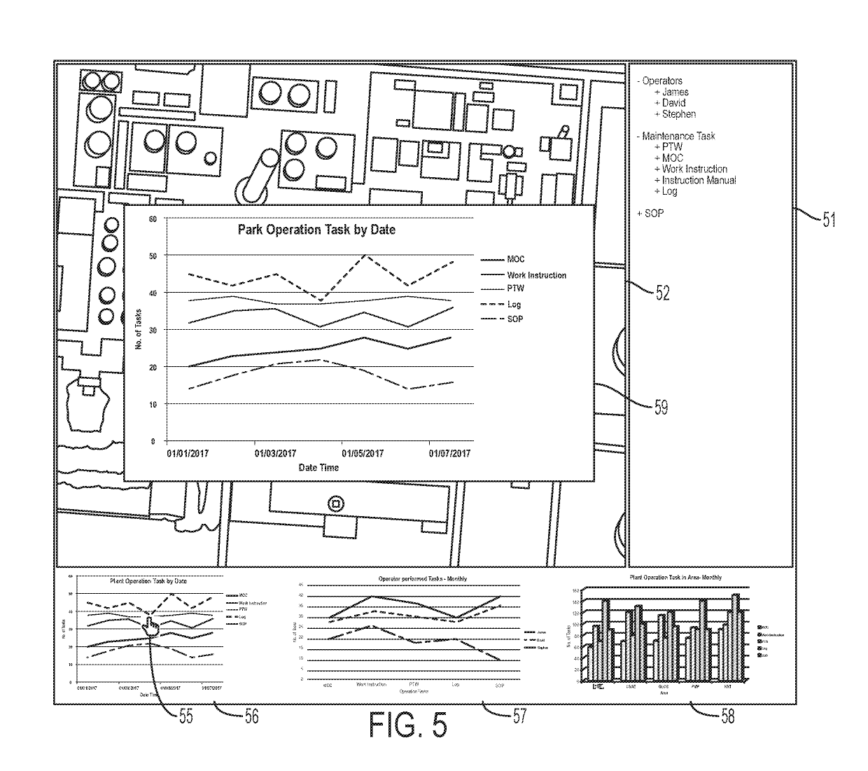

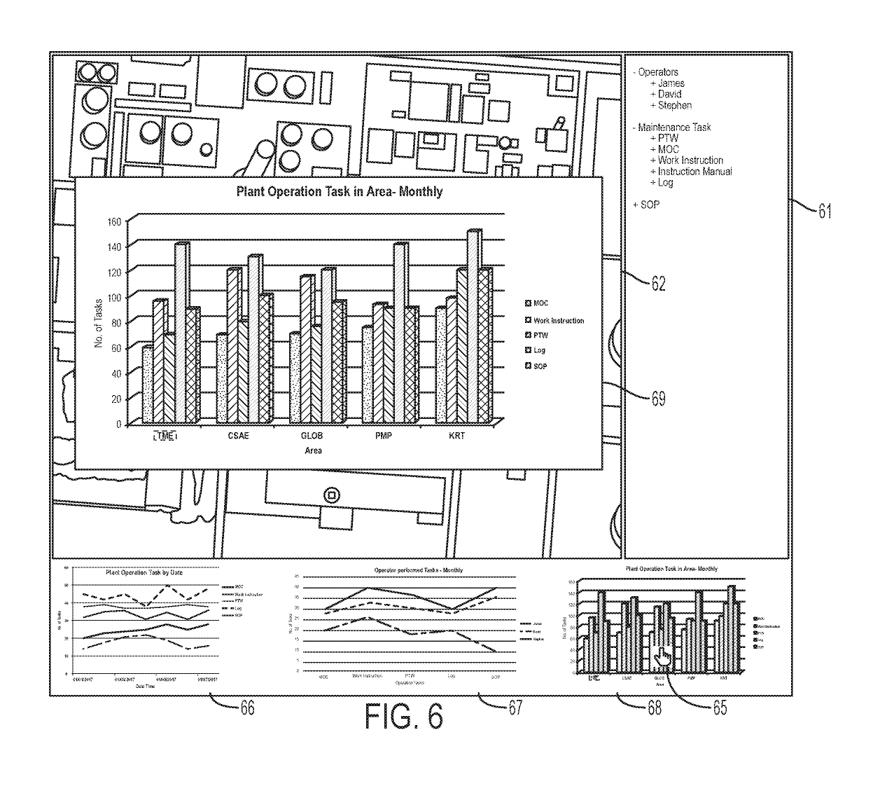

Further, as illustrated in FIGS. 5 and 6, using the cursor 55, 65 to select one of the trend graphs results in a displaying of the selected graph in a large view 59, 69 on top of the map 52, 62 for detailed review. Embodiments still continue to maintain the displaying of the other display elements including the text region 51, 61 and displaying a plurality of graphs 55, 56, 57, 65, 66, 67.

Embodiments of the task analyzer 23 can also calculate statistics from the tasks and historical records for task operations. In this way, patterns can be identified and projections can be made for future tasks. For example, for a particular type of task, the task analyzer 23 may be configured to find the frequency or regularity of occurrence for a particular time frame or area of the plant. The task analyzer may also compare the occurrence pattern between different types of tasks.

Embodiments of the task analyzer 23 can also provide an operator's task operation efficiency, identify hot spots in the plant and the corresponding risk factors, subsequently provide task operation decision making suggestions, and compile the determinations and suggestions into a task operation shift handover report.

For example, the task analyzer may calculate and suggest scheduling for a task based on a prediction of the required time, resources, tools, and skillset of the operators to accomplish a particular task from data from a similar task in a different area of the plant.

Also, based on the likelihood of different types of tasks for a same or different area under similar plant being necessary, the task analyzer may calculate and suggest scheduling for a task based on a prediction of what type of task should be created, the required time, resources, tools, and skillset of the operators to determine the scheduling of a task.

Additionally, the task analyzer 23 can calculate and determine a current safety risk, predict near future safety risk, and preventatively inform the operators.

Plant Patrol Routing Optimizer

The geolocation based plant patrol routing optimizer 24 of FIG. 2 is configured to optimize operation routing based on the calculation results and determinations of the geolocation enabled task analyzer 23. The patrol routing optimizer 24 is configured to provide a routing check list and standard operating procedures (SOP) for verification of normal operation of plant components in order to improve the efficiency of a plant patrol. The patrol routing optimizer 24 keeps track of a patrol operator's routing in real time through a location tracking system. The tracking of the patrol operator may be accomplished by at least one of multiple methods, including radio frequency, optical, or acoustic based tracking systems.

The patrol routing optimizer 24 also keeps track of a patrol operator's routing task operation data. The routing task operation data may include what routing task has been performed, the duration of time spent for the particular task, the type of checklist used, and the SOP that was executed.

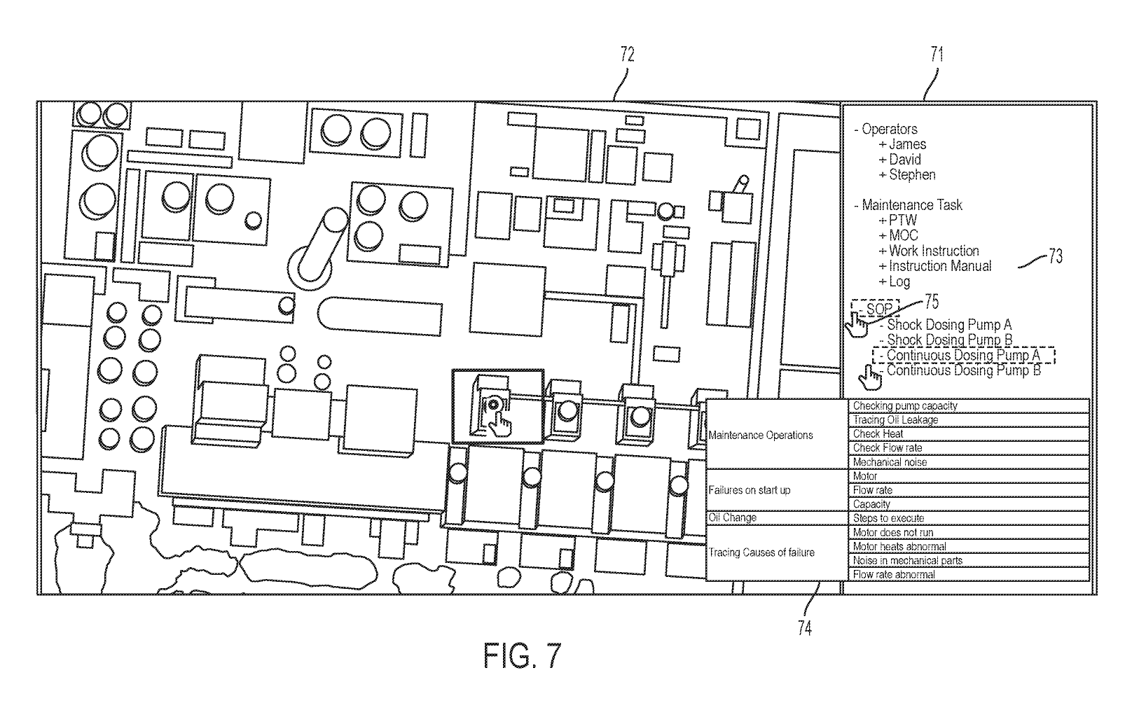

FIG. 7 illustrates an exemplary embodiment of a graphical display with a text region 71 and a map 72 of the industrial plant. The operator is also provided the use of a cursor 75, which, in addition to acting on the map 72, allows the operator to research information from the text region 71. For example, the operator can research information from the maintenance task list 73. Also, the operator can delve into the SOP of a particular area and see a checklist 74 of steps that can aid the operator in ensuring normal operation.

The patrol routing optimizer 24 can check patrol routing history data, whether any repeated task has occurred, whether similar tasks were performed, and what the task performance trend is with similarly featured tasks. From these considerations, the patrol routing optimizer can determine whether the routing task needs to be optimized and determine a suggestion. The suggestion for optimization may include changing the routing point sequence, changing the task operation order, or changing the operator for another operator with a different skillset. Considerations for changing the patrol routing may include efficiency concerns of task operation duration and reoccurrence of the task. The patrol routing optimizer will provide the checklist and SOP information necessary for the tasks of the patrol route, in order to help the operator perform the tasks efficiency.

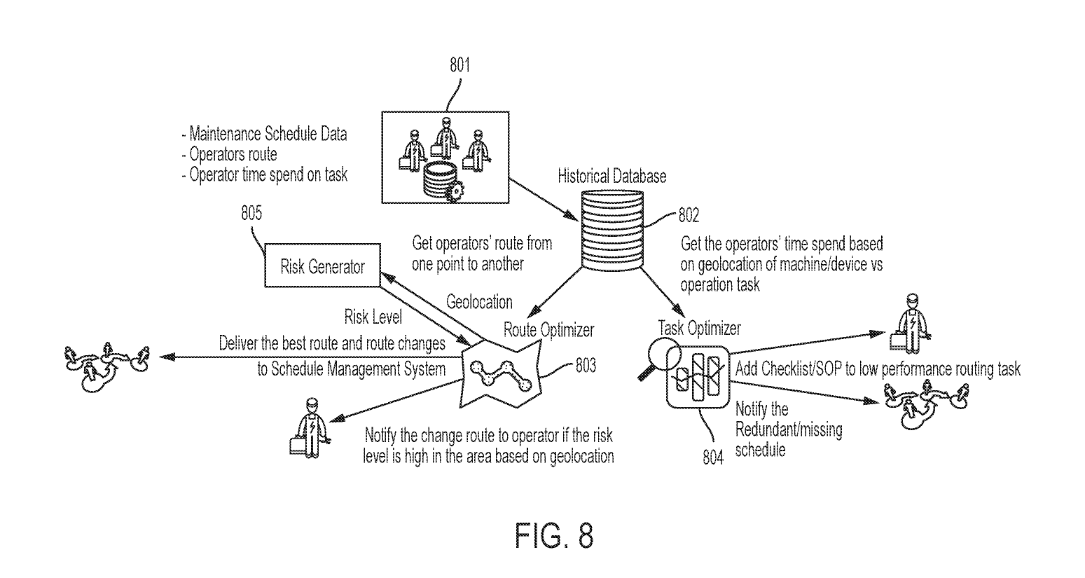

FIG. 8 illustrates an exemplary embodiment of the patrol routing optimizer 24 with a route optimizer 803 and a task optimizer 804. The router optimizer 803 and task optimizer 804 get information regarding the operator's route from a database 802 that stores information including maintenance schedule, operator routing, and the time an operator spends on a task. The router optimizer 803 can check the route of operators in the field at a set interval. A normal interval may be every 5 minutes. The task optimizer 804 checks for redundant or missing tasks and notifies a schedule management system for potential rescheduling of the task. In the case of a new or missing task, the patrol routing optimizer 24 may reroute a closest operator to complete the task.

From these considerations of rerouting, it is possible that an operator can have a new route assigned in order to cover a missed task. Additionally, based on a calculated risk from a risk generator 805, it is possible that automatically reroute the patrol path of the patrol operator to avoid a high level risk zone.

Real-Time Risk Monitor

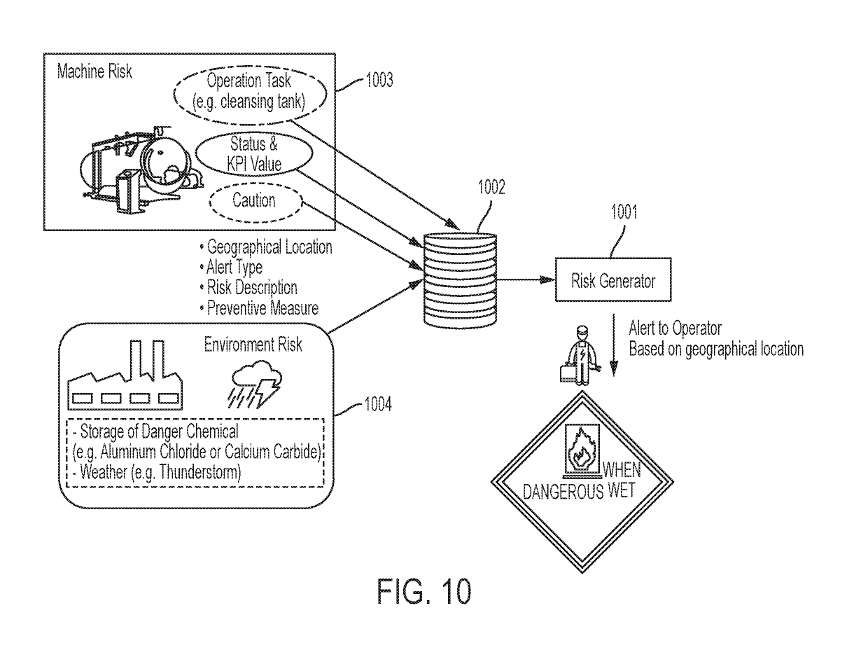

FIG. 10 illustrates a flowchart of the basis for the real-time risk monitor 25. The real-time risk monitor 25 includes a risk generator 1001 that is configured to alert an operator to warnings based on geolocation data. The risk generator 1001 retrieves information stored in a database 1002 relating to machine risk 1003 and to environment risk 1004.

Based on the status of the plant component or the environment, the real-time risk may change. For example, there is a higher real-time risk to be around dangerous chemicals during severe weather.

The real-time risk monitor 25 provides for tracking the patrol operator's routing task operation data, included completed routing tasks, the operator's current location, the risk factor of the area of the operator, a coefficient of risk based on the task and a location feature, such as a type or the condition of the asset or component. The machine risk, location risk, task related risk, and the environment risk may each have a coefficient or numerical indication of risk. Based on the combination of the coefficients, the coefficient of risk in real-time can be determined. When the coefficient of risk in real-time exceeds a predetermined threshold, then the area of the plant may be deemed at risk. There may be multiple levels of predetermined thresholds to indicator different levels of severity of risk.

Accordingly, the real-time risk monitor is to real time analyze plant operator's task feature, which is under performing, and the operator's location tracking data, to identify the risk factor and give alarm and real time notification when the risk exceeds the thresholds, which are configured during system engineering.

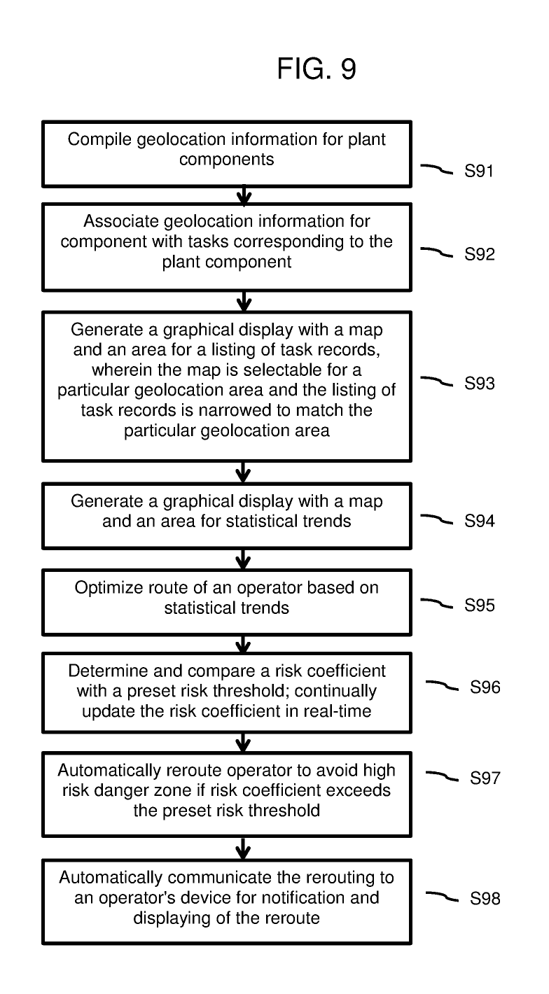

FIG. 9 illustrates a flowchart of an exemplary embodiment for automatically rerouting an operator based on risk monitoring. In step S91, the method includes compiling geolocation data for plant components. In step S92, geolocation data for the plant component is associated with tasks corresponding to the plant component. A graphical display with a map and an area for a listing of task records, wherein the map is selectable for a particular geolocation area and the listing of task records is narrowed to match the particular geolocation area is generated in step S93. Then, a graphical display with a map and an area for statistical trends is generated in step S94. Based on the statistical trends, the route of an operator is optimized in step S95. A determination of a risk coefficient for a plant machine or component and an environment is made, and it is compared to a risk threshold in step S96. The checking of the risk determination is continually made in real time. If the risk coefficient exceeds that present risk threshold in step S97, there is automatic rerouting of the operator to avoid the high risk danger zone. The rerouting is automatically communicated to the operator for notification and display of the reroute.

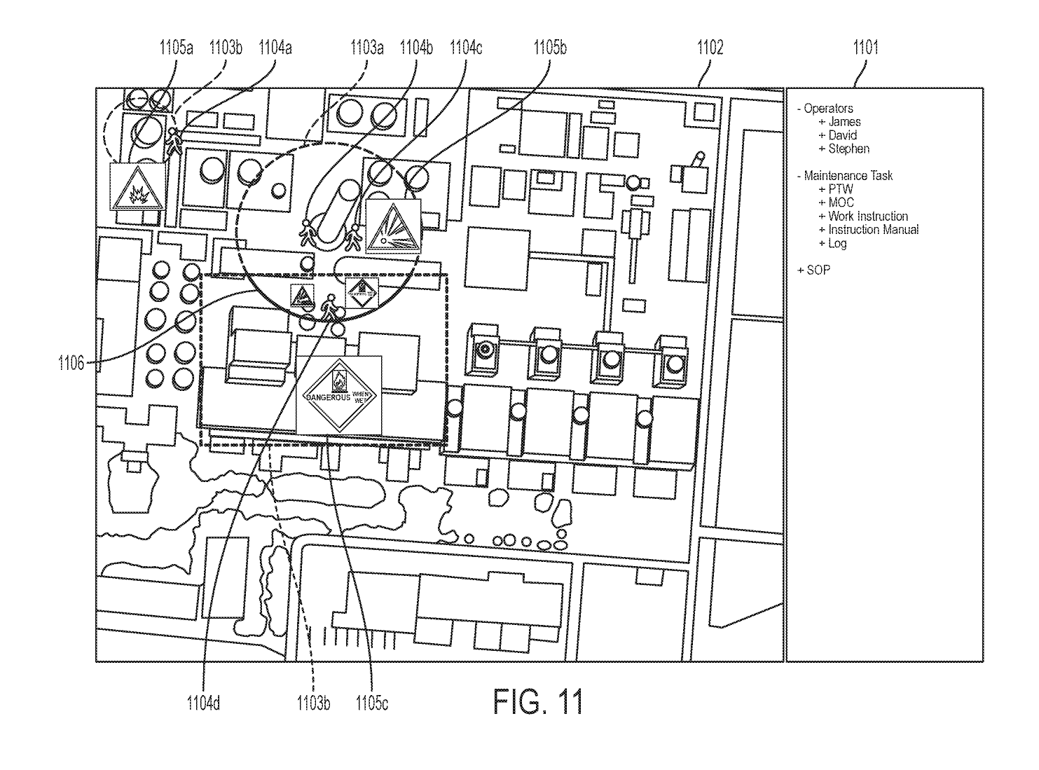

FIG. 11 illustrates an exemplary graphical display showing the outputs of the risk generator 1001. The graphical display includes a text region 1101 and a map 1102 of the industrial plant. In view of determined high-risk areas, the map displays an intuitive visualization of individual risk and high risk areas that are determined from the geolocation of machine/component risk and environmental risk. When there is an overlapping between two or more risk areas, the overlapping region 1106 is highlighted and indicated with a high alert. The highlighting may include graphical representation such as outlining of the overlapping region or a predetermined color shading of the overlapping region. Hotspot risk areas are indicated by the shapes displayed on the map 1103a-c. Additionally, specific signs 1105a-c, such as those indicating particular environmental risks, are shown within the high risk areas for clarification. By usage of the geolocation data, the operators in the field 1104a-c are also shown, such that supervisors and the operators themselves can easily understand their position relative to high risk areas.

Embodiments providing the real-time risk monitor 25 provide an intuitive visualization of individual risk and high risk area. In this way, a supervisory or management team can readily understand their positioning relative to danger zones. In some embodiments, the system will automatically notify the operators of their potential danger.

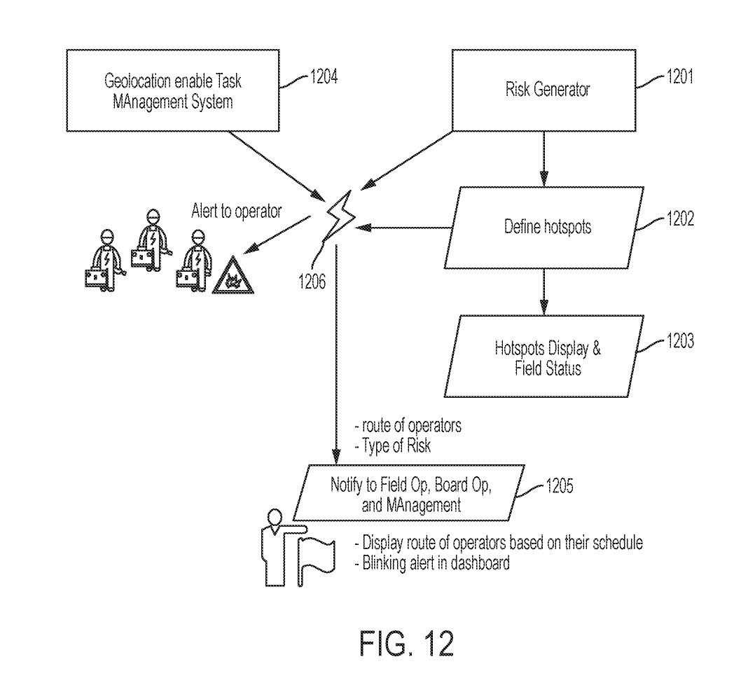

FIG. 12 illustrates an exemplary embodiment of the real-time risk monitor 1206 with a risk generator 1201. After the risk generator 1201 has determined that certain areas of the plant are at risk, the hotspots of risk 1202 can be defined. These hotspots can then be displayed, similarly as shown in FIG. 11. Upon the determination of hotspots of risks 1202 and interfacing with the task management system, the real-time risk monitor 1206 can notify the field operators and management.

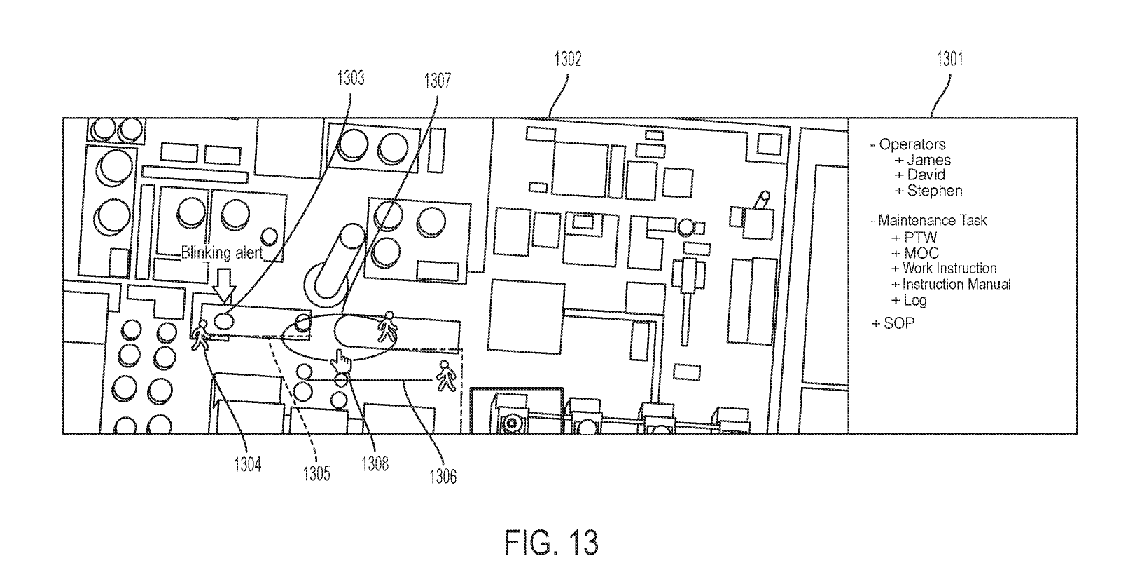

FIG. 13 illustrates an exemplary graphical display showing the outputs of the real-time risk monitor. The graphical display includes a text region 1301 and a map 1302 of the industrial plant. In view of determined high-risk areas, the map displays an intuitive visualization of individual risk and high risk areas that are determined from the geolocation of machine/component risk and environmental risk. Hotspot risk areas are indicated by the shapes displayed on the map 1307. Additionally, in the case of a first path 1305 that enters into a hotspot, there is a blinking alert for an individualized alert for the operator who enters or gets close to a danger zone hotspot. Also, the real-time risk monitor 1206 could alternatively notify and reroute an operator to a second path 1306 outside of the danger zone hotspot if the risk is judged to be higher than predetermined threshold.

Geolocation Based Plant Operation Task KPI Dashboard

The geolocation based plant operation task key performance indicator (KPI) dashboard 26 of FIG. 2 is configured to provide a graphical display with a map view based dashboard for an operator to organize, view and search and analyze plant operation task KPIs.

Embodiments may provide for the organization and presentation of KPIs in a map view similar to FIG. 3 or 4. Instead of general log information as in FIG. 3, it may be possible to display KPI information in the display area of area of records 34. In view of the correlation of geolocation data with tasks, selection of a particular area can then focus the area of interest with displaying KPIs to display the KPIs for the selected particular area. The shape of the particular area may be preset in shape and size, or it may be specifiable by use of a cursor and drawing a shape on the map. For example, the shapes of the particular area may be a rectangle, circle, ellipse, triangle, or a freeform polygon. Upon selection of a particular area, the display of the map may also scale to provide sufficient detail for the desired particular area. The KPIs may also be used for a diagnostic failsafe to monitor for abnormal behavior in plant processes.

Additionally, although the present application discloses rerouting of operators for inspection, it can be envisioned that the optimized route and the redetermined route could be applied to robots or drones. In such a scenario, the drone may automatically execute the redetermined route upon receipt of the communication notifying it of the redetermined route.

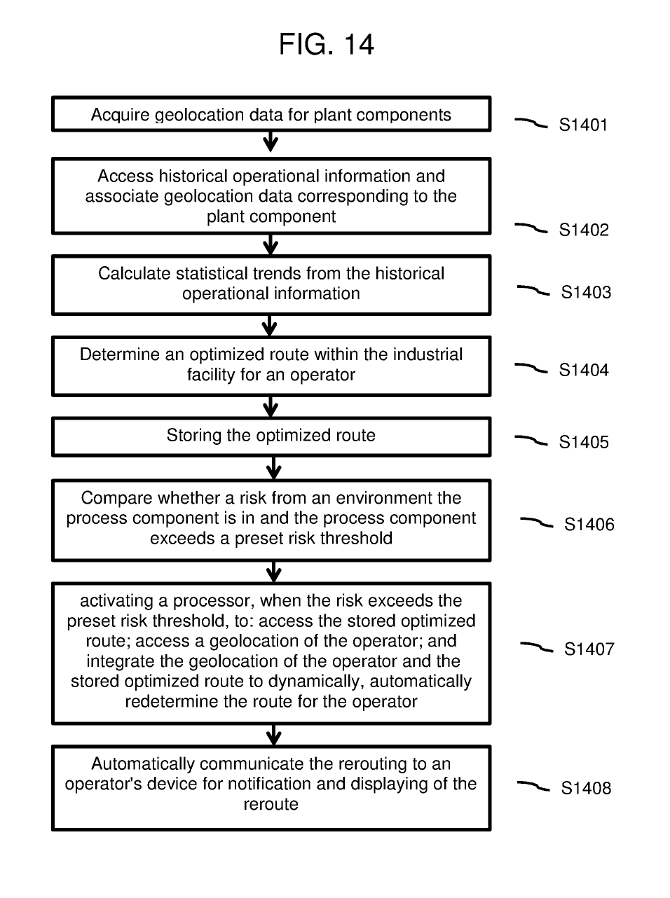

Accordingly, FIG. 14 shows an exemplary embodiment of the plant operation management system. In step S1401, the system can acquire geolocation data for plant components. In step S1402, the system accesses historical operational information and associates geolocation data corresponding to the plant component. In step S1403, the system calculates statistical trends from the historical operational information. In step S1404, there is determination of an optimized route within the industrial facility for an operator. In step 51405, the optimized route can be saved into storage. In step S1406, there is a comparison to see if a risk from an environment the process component is in and the process component exceeds a preset risk threshold. In step S1407, there is activation of a processor, when the risk exceeds the preset risk threshold, to: access the stored optimized route; access a geolocation of the operator; and integrate the geolocation of the operator and the stored optimized route to dynamically, automatically redetermine the route for the operator. Upon redetermination of the route, there is automatic communication of the rerouting to an operator's device for notification and displaying of the reroute.

Operational Efficiency Review

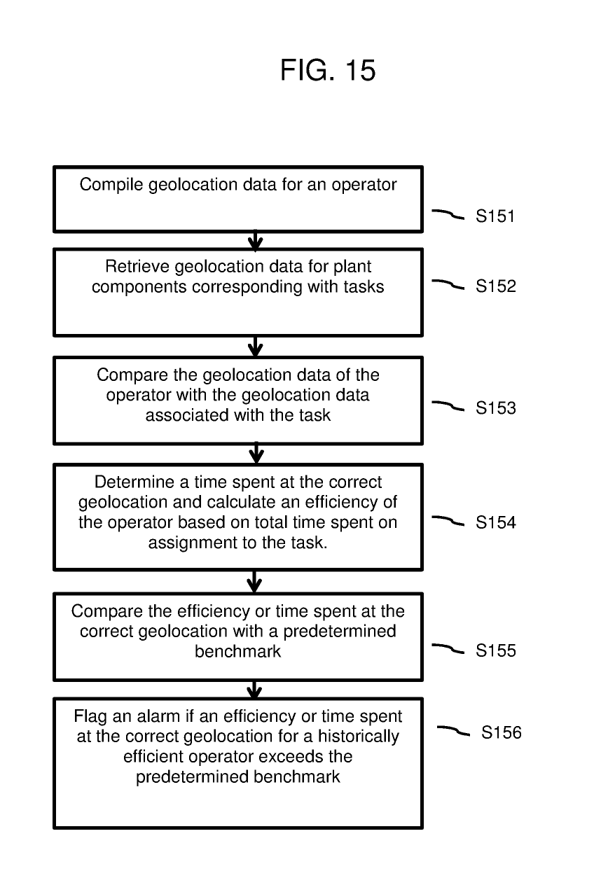

Based on the usage of geolocation with the operation management system, improvements in operational efficiency can be achieved. Without geolocation information, a traditional operation management system can only provide information on the time spent by an operator while on assignment for a task. This results in a lack of detailed information on time allocation while on assignment. In contrast, correlation with geolocation can provide location information of the operator for detailed analysis of how much time was specifically spent on the task. This can be used to check for worker efficiency. FIG. 15 shows an exemplary flowchart illustrating this. In step S151, the geolocation data for an operator can be gathered. In step S152, geolocation data for the task can be retrieved. In step S153, a comparison can be made between the two geolocation datasets. For example, in a case where the operation management system records that an operator spent two hours for maintaining a device, the geolocation information can show that the operator spent one of those hours at a location other than where the device is located. From the information, it can be determined that only one hour was actually spent on the task. In step S154, a time spent at the correct geolocation can be determined and an efficiency of the operator can be calculated based on the total time spent on assignment to the task. In step S155, the efficiency or time spent at the correct geolocation can be compared with a predetermined benchmark. Actual time spent for the task can then be compared among operators to determine a bench mark for necessary time for the task and compatibility between operators and the assigned task. By assigning tasks to the appropriate, or efficient, operators, the time spent can be shortened and operation efficiency can be improved. Also, an abnormal situation relating to a task can be determined, if a skillful operator requires more time than normal. Such indication of abnormality could be used to flag the task or device for further evaluation and management, as in step S156.

Although this specification has been described above with respect to the exemplary embodiments, it shall be appreciated that there can be a variety of permutations and modifications of the described exemplary features by those who are ordinarily skilled in the art without departing from the technical ideas and scope of the features, which shall be defined by the appended claims.

A method of one or more exemplary embodiments may be recorded as computer-readable program codes in non-transitory computer-readable media (CD ROM, random access memory (RAM), read-only memory (ROM), floppy disks, hard disks, magneto-optical disks, and the like) including program instructions to implement various operations embodied by a computer.

While this specification contains many features, the features should not be construed as limitations on the scope of the disclosure or of the appended claims. Certain features described in the context of separate embodiments can also be implemented in combination. Conversely, various features described in the context of a single exemplary embodiment can also be implemented in multiple exemplary embodiments separately or in any suitable sub-combination.

Also, it should be noted that all embodiments do not require the distinction of various system components made in this description. The device components and systems may be generally implemented as a single software product or multiple software product packages.

A number of examples have been described above. Nevertheless, it is noted that various modifications may be made. For example, suitable results may be achieved if the described techniques are performed in a different order and/or if components in a described system, architecture, or device are combined in a different manner and/or replaced or supplemented by other components or their equivalents. Accordingly, other implementations are within the scope of the following claims.

There is claimed:

1. A method for integration of geolocation data with operation management of an industrial automation process for an industrial facility for risk assessment, the method comprising:
acquiring geolocation data for a process component within the industrial facility;
accessing historical operational information for the process component, and associating the geolocation data of the process component with the historical operational information of the process component;
calculating statistical trends from the historical operational information;
determining an optimized route within the industrial facility for an operator based on the statistical trends;
storing the optimized route;
comparing whether a risk from an environment the process component is in and the process component exceeds a preset risk threshold;
activating a processor, when the risk exceeds the preset risk threshold, to:
access the stored optimized route;
access a geolocation of the operator; and
integrate the geolocation of the operator and the stored optimized route to dynamically, automatically redetermine the route for the operator;
automatically sending a communication for displaying and notifying the operator of the redetermined route.

2. The method according to claim 1, further comprising:
displaying a first graphical display with a map and an area for a listing of the historical operational information, wherein the map is selectable for a particular geolocation area and the listing of the historical operational information is narrowed to match the particular geolocation area

3. The method according to claim 2, further comprising:
displaying a second graphical display with the map and an area for the statistical trends from the historical operational information.

4. The method according to claim 1, further comprising:
sending an alert to a remote management device when the risk exceeds the preset risk threshold.

5. The method according to claim 1, wherein the communication for displaying and notifying the operator of the redetermined route comprises a task and standard operating procedure steps for completion of the task.

6. The method according to claim 1, further comprising:
displaying an indication demarcating a high-risk area of the industrial automation process where the risk exceeds the preset risk threshold.

7. A system for integration of geolocation data with operation management of an industrial automation process for an industrial facility for risk assessment, the system comprising:
a process component;
at least one non-transitory computer readable storage medium operable to store program code;
at least one processor operable to read said program code and operate as instructed by the program code, the program code comprising:
acquiring geolocation data for one of the process component within the industrial facility;
accessing historical operational information for the process component, and associating the geolocation data of the process component with the historical operational information of the process component;
calculating statistical trends from the historical operational information;
determining an optimized a route within the industrial facility for an operator based on the statistical trends;
comparing whether a risk from an environment the process component is in and the process component exceeds a preset risk threshold;
activating the processor, when the risk exceeds the preset risk threshold, to:
access the stored optimized route;
access a geolocation of the operator; and
integrate the geolocation of the operator and the stored optimized route to dynamically, automatically redetermine the route for the operator;
automatically sending a communication for displaying and notifying the operator of the redetermined route.

8. The system according to claim 7, the program code further comprising:
displaying a first graphical display with a map and an area for a listing of the historical operational information, wherein the map is selectable for a particular geolocation area and the listing of the historical operational information is narrowed to match the particular geolocation area

9. The system according to claim 8, the program code further comprising:
displaying a second graphical display with the map and an area for the statistical trends from the historical operational information.

10. The system according to claim 7, the program code further comprising:
sending an alert to a remote management device when the risk exceeds the preset risk threshold.

11. The system according to claim 7, wherein the communication for displaying and notifying the operator of the redetermined route comprises a task and standard operating procedure steps for completion of the task.

12. The system according to claim 7, the program code further comprising:
displaying an indication demarcating a high-risk area of the industrial automation process where the risk exceeds the preset risk threshold.
